(19) United States
(12) Patent Application Publication
(10) Pub. No.: US 2020/0095811 A1
(43) Pub. Date: Mar. 26, 2020

(54) WINDOW ASSEMBLY INCLUDING HINGED PANEL

(71) Applicant: Larson Manufacturing Company of South Dakota, Inc., Brookings, SD (US)

(72) Inventors: Kelly D. Nordgaard, Gary, SD (US); Lucas M. Hemmen, White, SD (US)

(21) Appl. No.: 16/580,739

(22) Filed: Sep. 24, 2019

Related U.S. Application Data
(60) Provisional application No. 62/735,303, filed on Sep. 24, 2018.

(51) Int. Cl. E05C 17/20; E06B 9/52; E05F 11/02

(52) U.S. Cl. CPC E05C 17/20; E06B 9/52; E05Y 2900/136; E06B 2009/527; E05F 11/02

(57) ABSTRACT

A window assembly including a master frame defining a master frame opening, a first window assembly secured within a first portion of the master frame opening, a screen member secured within a second portion of the master frame opening adjacent to the first window assembly, a second window assembly pivotably attached relative to the second portion of the master frame opening, and a window opening system that includes at least one extending arm pivotably attached to the second window assembly and extending through an opening in at least one of the screen member and a screen frame in which the screen member is secured, the extending arm(s) having at least one arm aperture, a flange extending from the master frame and comprising at least one flange aperture, and a locking member engageable with one of the arm apertures and one of the flange apertures.

This application claims the benefit of U.S. Provisional Patent Application No. 62/735,303, filed Sep. 24, 2018 and titled “WINDOW ASSEMBLY INCLUDING HINGED PANEL” which application is incorporated herein by reference in its entirety.

### TECHNICAL FIELD

The present invention relates to window assemblies having a fixed mesh or screen panel and a hinged solid panel, and more particularly relates to a window assembly having a glass panel that is hinged to swing outwardly to one or more positions relative to a fixed mesh or screen panel.

### BACKGROUND

Window openings in buildings often include a combination of glass and screen panels that can be configured by the user to provide a desired environment within a room. For example, if it is desired to prevent outside air from entering a room, one or more glass panels can be moved to a closed position, and the glass panels can optionally be locked to each other or to a window frame. Alternatively, if it is desired to allow outside air to enter a room, the glass panels can be adjusted to expose one or more screens. In some cases, the windows are configured so that sliding one or more glass panels along tracks in a vertical or horizontal direction within the window frame will expose and cover the screens, as desired. In other cases, the window portion can be hinged relative to the window frame to expose and cover the screen, such as with a rotatable crank positioned on the portion of the window frame facing into the room.

In certain environments, such as in buildings commonly known as “rackhouses,” numerous barrels of alcoholic beverages are stored on racks while they are aging. The air circulation provided by open or partially open windows can be important to certain alcohol aging processes; however, it is also important that rainwater and birds or other animals are prevented from entering the rackhouse through open window openings. While certain window configurations with screens can provide some of these features, there is a need to provide improved window assemblies that allow for adjustable and consistent air circulation while preventing the undesired entry of rainwater and undesired pests.

### SUMMARY

In one embodiment described herein, a window assembly is provided that comprises a master frame comprising an inner peripheral edge defining a master frame opening, a first window assembly secured within a first portion of the master frame opening, a screen member (which may optionally be secured within a screen frame) secured within a second portion of the master frame opening adjacent to the first window assembly, a second window assembly pivotably attached relative to the second portion of the master frame opening, and a window opening system. The window opening system includes at least one extending arm pivotably attached to the second window assembly and extending through an opening in at least one of the screen member and the screen frame in which the screen member is secured, the at least one extending arm comprising at least one arm aperture, a flange extending from the master frame and comprising at least one flange aperture, and a locking member engageable with one of the at least one arm aperture and one of the at least one flange aperture.

The at least one extending arm can be pivotably attached at a distal end to the second window assembly. Alternatively or additionally, the at least one extending arm can be pivotably attached to the second window assembly at a pivot point that is spaced from the distal end of the at least one extending arm.

The at least one arm aperture can include a plurality of arm apertures, and/or the at least one flange aperture can include a plurality of flange apertures. In an aspect of the window assembly, the at least one arm aperture comprises a first arm aperture and a second arm aperture, wherein the at least one flange aperture can include a first flange aperture and a second flange aperture such that the first arm aperture is alignable with the first flange aperture when the second window assembly is in a first window position and such that the second arm aperture is alignable with the second arm aperture when the second window assembly is in a second window position.

Further, the locking member may be engaged with the first arm aperture and the first flange aperture when the second window assembly is in the first window position, and the locking member may be engaged with the second arm aperture and the second flange aperture when the second window assembly is in the second window position. The locking member may include a post, which may be threaded. The assembly may include a secondary screen covering at least a portion of the screen member.

In another embodiment, a window assembly may include a master frame comprising an inner peripheral edge defining a master frame opening, a first window assembly secured within a first portion of the master frame opening, a screen member (which may optionally be secured within a screen frame) secured within a second portion of the master frame opening adjacent to the first window assembly, a second window assembly pivotably attached relative to the second portion of the master frame opening, and a window opening system. The window opening system may include a first extending arm pivotably attached at a distal end to the second window assembly and extending through a first opening in at least one of the screen member and the screen frame in which the screen member is secured, the first extending arm comprising at least one first arm aperture, a second extending arm pivotably attached at a distal end to the second window assembly and extending through a second opening in at least one of the screen member and a screen frame in which the screen member is secured and that is spaced from the first opening, the second extending arm comprising at least one second arm aperture, a first flange extending from the master frame and comprising at least one first flange aperture, a second flange spaced from the first flange, extending from the master frame, and comprising at least one second flange aperture, a first locking member engageable with one of the at least one first arm aperture and one of the at least one first flange aperture, and a second locking member engageable with one of the at least one second arm aperture and one of the at least one second flange aperture.

In another embodiment, a window assembly includes a master frame comprising an inner peripheral edge defining a master frame opening, a screen member secured within the master frame opening (wherein the screen member may optionally be secured within a screen frame), a first window assembly pivotably attached relative to the master frame opening, and a window opening system. The window opening system may include at least one extending arm pivotably attached to the first window assembly and extending through an opening in at least one of the screen member and the optional screen frame in which the screen member is secured, the at least one extending arm comprising at least one arm aperture, a flange extending from the master frame and comprising at least one flange aperture, and a locking member engageable with one of the at least one arm aperture and one of the at least one flange aperture. The at least one extending arm can be pivotably attached at a distal end to the first window assembly. Alternatively or additionally, the at least one extending arm can be pivotably attached to the first window assembly at a pivot point that is spaced from the distal end of the at least one extending arm.

### BRIEF DESCRIPTION OF THE DRAWINGS

The present invention will be further explained with reference to the appended Figures, wherein like structure is referred to by like numerals throughout the several views, and wherein;

FIG. 1 is a front or outer view of an embodiment of a window assembly, in accordance with the invention;

FIG. 2 is a back or inner view of the window assembly of FIG. 1;

FIG. 3 is a perspective view of the window assembly of FIG. 1 in a closed position;

FIG. 4 is a perspective view of the window assembly of FIG. 1 with the window in an open position, as viewed from the front or outer side of the window assembly;

FIG. 5 is a perspective view of the window assembly of FIG. 1 with the window in an open position, as viewed from the back or inner side of the window assembly;

FIG. 6 is an enlarged perspective view of the lower portion of the window assembly of FIG. 5 in an open position;

FIG. 7 is an enlarged perspective view of the lower portion of the window assembly of FIG. 1 with the window in a partially open position, as viewed from the back or inner side of the window;

FIG. 8 is a an enlarged perspective view of the lower portion of the window assembly of FIG. 1 with the window in a closed position, as viewed from the back or inner side of the window;

FIG. 9 is a cross-sectional side view of the window assembly of FIG. 1, taken along section line 9-9;

FIG. 10A is an enlarged a cross-sectional side view of a top portion of the window assembly of FIG. 9;

FIG. 10B is an enlarged cross-sectional side view of a middle portion of the window assembly of FIG. 9;

FIG. 10C is an enlarged a cross-sectional side view of a bottom portion of the window assembly of FIG. 9;

FIG. 11 is a front or outer view of another embodiment of a window assembly, in accordance with the invention;

FIG. 12 is a perspective view of the window assembly of FIG. 11 with the window in an open position, as viewed from the front or outer side of the window assembly;

FIG. 13 is a cross-sectional side view of the window assembly of FIG. 11, taken along section line 13-13;

FIG. 14A is an enlarged cross-sectional side view of a top portion of the window assembly of FIG. 13;

FIG. 14B is an enlarged cross-sectional side view of a bottom portion of the window assembly of FIG. 13;

FIG. 15 is a perspective view of the lower portion of an embodiment of a window assembly in an open position, as viewed from the back or inner side of the window;

FIG. 16 is an enlarged perspective view of the lower portion of the window assembly of FIG. 15 with the window a partially open position, as viewed from the back or inner side of the window;

FIG. 17 is a an enlarged perspective view of the lower portion of the window assembly of FIG. 15 with the window in a closed position, as viewed from the back or inner side of the window;

FIG. 18 is a perspective view of an embodiment of a window assembly with two windows in an open position, as viewed from the front or outer side of the window assembly; and

FIG. 19 is a perspective view of the window assembly of FIG. 18 with the windows in an open position, as viewed from the back or inner side of the window assembly.

### DETAILED DESCRIPTION

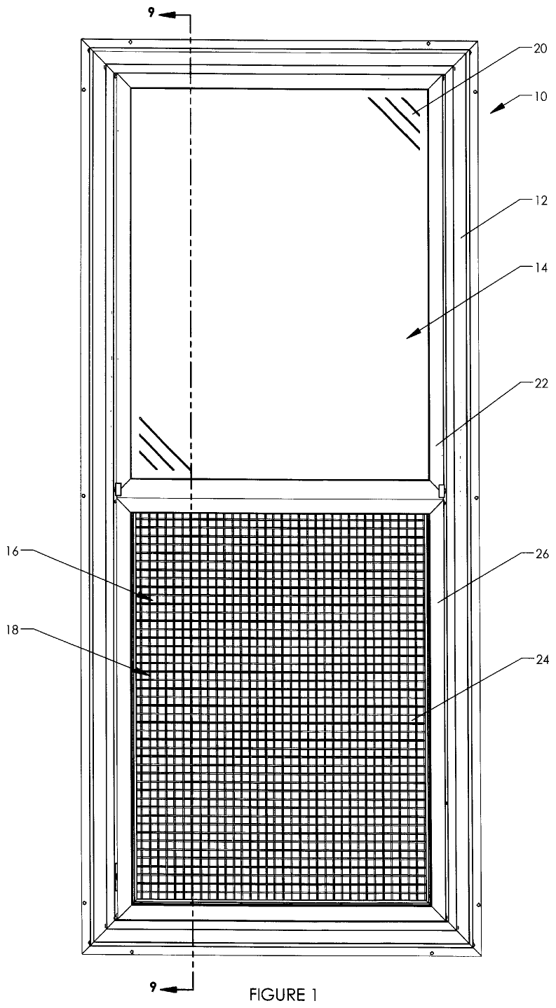

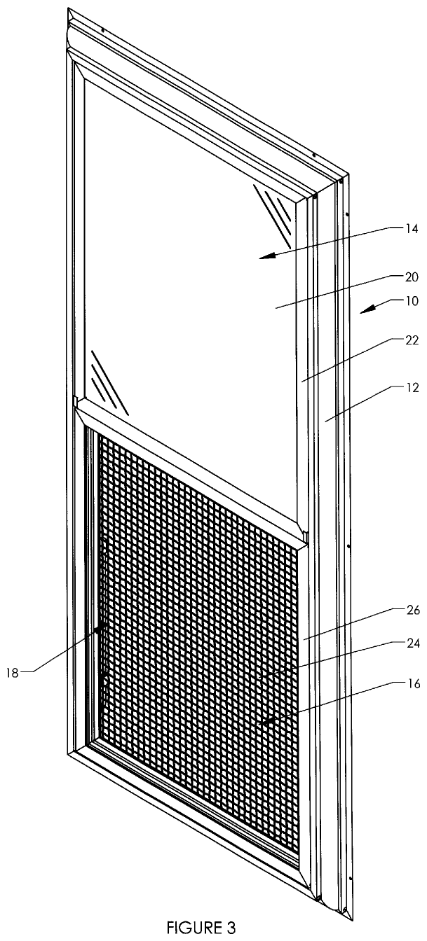

Referring now to the Figures, wherein the components are labeled with like numerals throughout the several Figures, and initially to FIGS. 1-8, an embodiment of a of a window assembly 10 is illustrated, which includes a master frame 12, a top glass member 14, and a bottom glass member 16 through which a bottom screen or mesh member 18 is visible. In this configuration, the top glass member 14 includes a glass panel 20 mounted within a top frame 22. The top frame 22 can be attached within the top portion of the master frame 12 in a number of ways, such as by sliding the top frame 22 into inner rails of master frame 12 (not shown) or by simply positioning it adjacent to the inner opening of the master frame 12, and locking it into place using screws, tabs, and/or other securing devices.

The bottom glass member 16 includes a glass panel 24 that can be mounted within a bottom frame 26. In an alternate embodiment, the glass member 16 does not include a frame. Bottom glass member 16 is positioned adjacent to the top glass member 14 at a hinged connection so that the bottom glass member 16 can be swung outwardly to allow for ventilation, as will be discussed in further detail below.

The screen or mesh member 18 includes a screen or mesh panel 28 optionally mounted within a screen frame 30. Screen or mesh member 18 or screen frame 30 can be attached within the bottom portion of the master frame 12 in a number of ways, such as by sliding the screen frame 30 into inner rails of the master frame 12 or by positioning it adjacent to the inner opening of the master frame 12 and locking it into place using one or more clips 32, as shown. Alternatively, the screen or mesh member 18 can be secured directly to the master frame 12. Clips 32 can be positioned on the side of the window assembly facing toward the inside of the building to provide access to remove and replace the screen or mesh member 18, for example, although it is possible that the screen member is held in place in another manner. Also, although four of such clips 32 are illustrated, it is contemplated that more or less than four clips or attachment members are used.

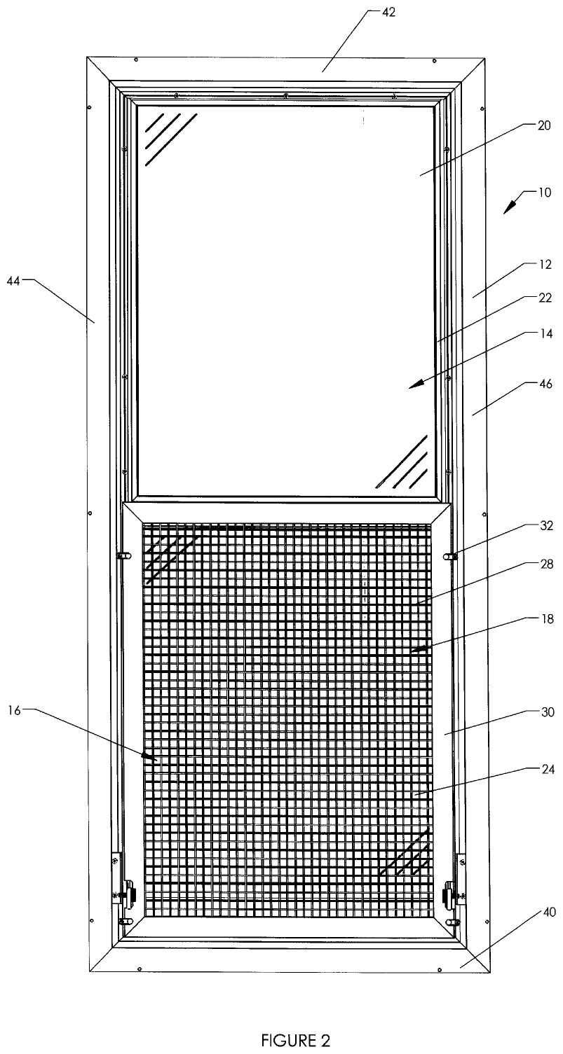

Referring particularly to FIG. 2 relative to an exemplary construction, master frame 12 includes a sill 40, a header 42 that is generally parallel to sill 40, a left jamb 44 extending between sill 40 and header 42, and a right jamb 46 that is spaced from and generally parallel to the left jamb 44, and that extends between sill 40 and header 42. Each of these four structural members includes mitered ends cut at an angle of approximately 45degrees. These four structural members 40, 42, 44, 46 can be connected to each other via four corner key members (not shown), each of which is located at one of the four corners and is provided to ensure that the miters align on the exterior surface of the master frame 12. Master frame 12 may further include one or more fasteners (e.g., screws) to correspond with each of the four corners when the frame is assembled. The sill 40, header 42, and left and right jambs 44, 46 can be made of extruded aluminum, molded or extruded plastic, or another relatively rigid material that is resistant to damage by impact and/or environmental factors. It is noted that the top frame 22 of top glass member 14, the bottom frame 26 of bottom glass member 16, and the screen frame 30 of screen member 18 can similarly be constructed of four members attached to each other by fasteners such as screws, adhesive, or other means, or can be constructed in another manner, as is known in the window industry.

Briefly referring to the enlarged cross-sectional views of FIGS. 10B and 10C, at least one of the structural members of the optional screen frame 30 may include a base 29 having an opening or channel in which an edge of the screen panel 28 can be inserted. When an edge of the screen panel 28 is positioned within this opening, a moveable portion of the base can be pivoted or moved until its contoured surface contacts a first side of the screen panel 28. The contoured surface of the moveable portion can correspond generally to a shaped surface of an opposing surface of the opening. Enough force is used when pressing these two surfaces toward each other to deform or crimp the screen panel 28 within the resulting opening or channel, as shown in FIGS. 10B and 10C. The channel can be configured with a different number and shape of contours and/or bends than illustrated. The process of crimping an edge of the screen panel 28 within each structural member is repeated for all four members of the screen frame 30. The crimping process serves to generate tension in the screen panel to keep it taut, rigid, and secure within the screen assembly.

The screen material used as the screen panel 28 can be stainless steel or another material that provides a desired amount of strength and rigidity, while also being relatively resistant to environmental factors, such as corrosion. The material from which the screen is made can include wires arranged in a grid pattern that is at least somewhat more open than that of a traditional insect screen in order to accommodate the thicker wires while still providing enough open space for viewing and/or air movement through the screen. In certain embodiments the grid pattern can be less open than that of a traditional insect screen. In other embodiments, the material used as the screen panel can be perforated sheet metal, expanded sheet metal, or other material known to one skilled the art that provides both air circulation and resistance to entry by birds or other animals. In still other embodiments, the window assemblies can include a secondary insect screen that can be positioned across at least a portion of the screen panel 28. This optional secondary screen can have a grid or opening pattern that is the same as or different than that of the screen panel 28.

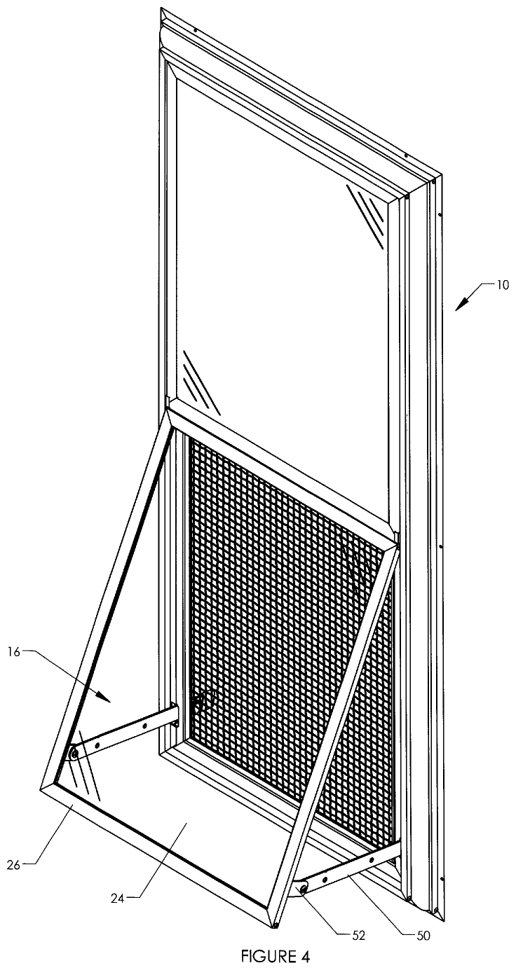

Referring now to FIGS. 4-6, the bottom glass member 16 is illustrated in one of its open positions, which in this embodiment is considered to be the fully open position of the bottom glass member 16. As shown, the top corners of the bottom frame 26 are hinged so that the bottom edge of the bottom frame 26 is spaced furthest from the master frame 12. In order to move the bottom frame away from the master frame 12, a window opening system is provided along one or both sides of the bottom frame 26 which generally includes an extending arm 50, a first bracket 52 secured to an inner side of the bottom frame 26 (or directly to the glass member 16, in an embodiment where the glass member does not include a frame), a second bracket 54 secured to an inner side of the master frame 12, and a locking member 56. Details of this system are described in further detail below.

First bracket 52 is a generally L-shaped member having a flange portion 58 that extends outwardly in a generally perpendicular direction from the inner surface of the bottom frame 26 to which it is attached. Flange portion 58 includes a pivot point 60 at which a distal end of the extending arm 50 is pivotally attached. The first bracket 52 can be a separate piece that is attached to the frame 26 or can be integral with the frame 26.

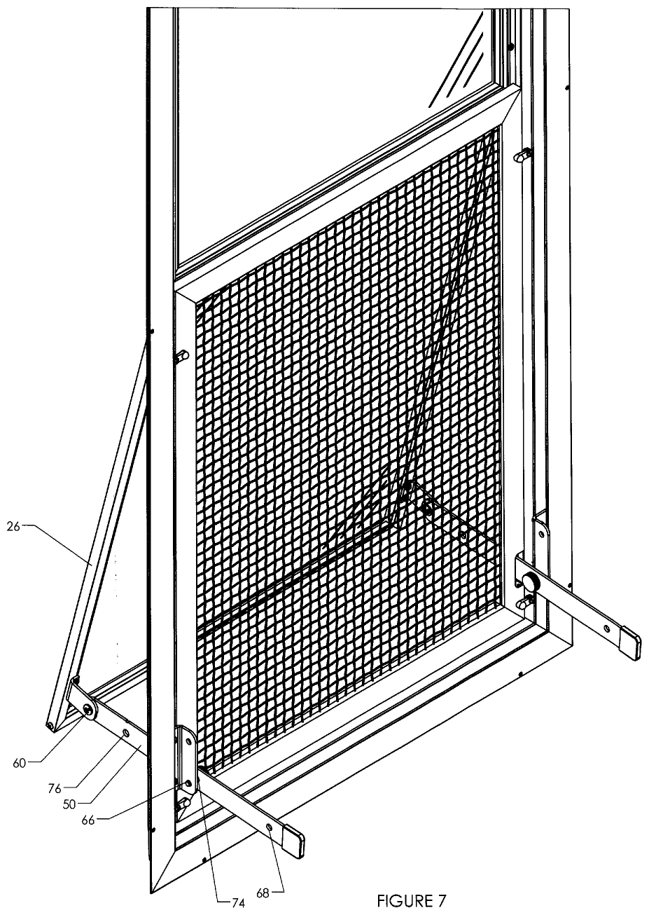

Second bracket 54 is also a generally L-shaped member having a flange portion 62 that extends outwardly in a generally perpendicular direction from an inner surface of the master frame 12 to which it is attached. The second bracket 54 can be a separate piece that is attached to the frame 12 or can be integral with the frame 12. Flange portion 62 includes at least an upper aperture 64 and a lower aperture 66 for engagement with a corresponding aperture of the extending arm 50. In particular, when in this fully open position, a first aperture 68 of extending arm 50 (clearly visible in FIG. 7) will be aligned with the lower aperture 66 of flange portion 62. In order to lock the extending arm 50 in this position, a post (which may be threaded) of locking member 56 is inserted through both the lower aperture 66 and the first aperture 68 until these components are secured. In one embodiment, the locking member 56 includes a knob 70 from which a threaded post extends, while the inner portion of one or both of the apertures 66, 68 includes corresponding threads such that the knob 70 can be turned and tightened until the threads of the post are adequately secured within the apertures 66, 68. The knob 70 may optionally include a knurled surface or other gripping surface to provide ease in gripping and manipulation thereof.

As is illustrated in the Figures, the optional screen frame 30 includes a gap or opening 72 for each corresponding extending arm 50. While the figures illustrate such openings 72 near the bottom left corner and bottom right corner of the screen frame 30, it is also possible that the openings 72 and corresponding extending arms 50 are differently spaced relative to the corners of the screen frame 30. For example, one of the openings 72 can be higher than the other opening 72 on the opposite side of the screen frame 30. In certain embodiments, positioning the openings 72 as close to the bottom of the screen frame 30 as possible will provide for easier access by people who are manipulating the extending arms 50. When a screen frame is not utilized and the screen or mesh member 18 is secured directly to the master frame 12, a gap or opening 72 for each corresponding arm may be extend directly through the screen or mesh member 18.

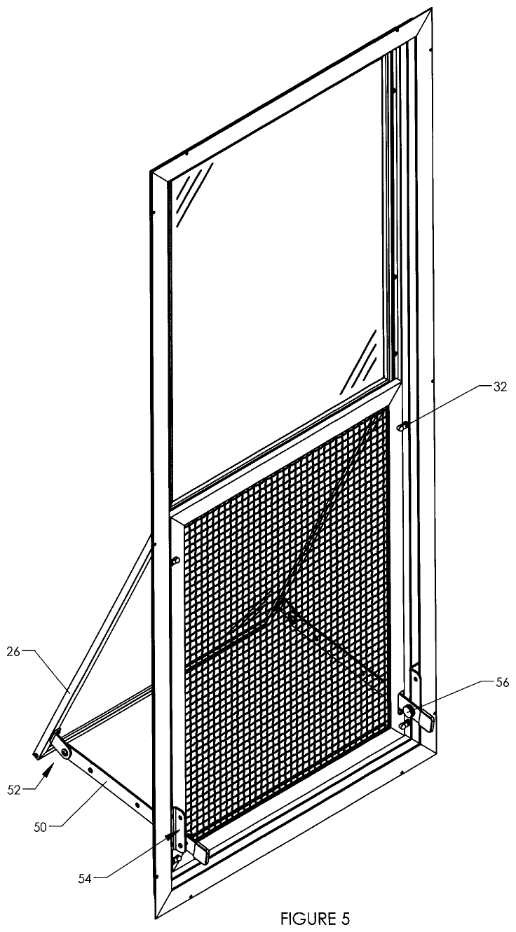

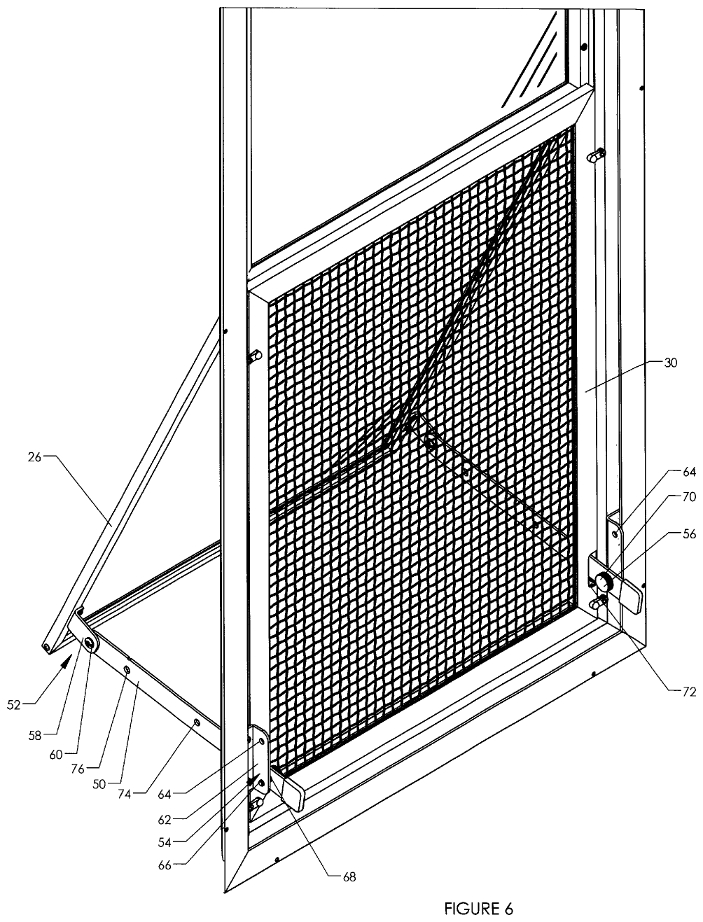

Referring now to FIG. 7, the bottom glass member 16 is illustrated in another of its open positions, which in this embodiment is considered to be a partially open position of the bottom glass member 16. In this configuration, the bottom edge of the bottom frame 26 of bottom glass member 16 is closer to the master frame 12 than when in its fully open position. When in this partially open position, a second aperture 74 of extending arm 50 (clearly visible in FIG. 6) will be aligned with the lower aperture 66 of flange portion 62. In order to lock the extending arm 50 in this position, a post of locking member 56 is inserted into both the lower aperture 66 and the second aperture 74 until these components are secured. In cases where the bottom glass member 16 is being moved from its fully open position to the partially open position, the locking member 56 is disengaged from the lower aperture 66 and first aperture 68, the extending arms 50 are pulled toward the user through their associated openings 72 until the second aperture 74 is aligned with the lower aperture 66, and then the locking member 56 is inserted through both the lower aperture 66 and the second aperture 74. As shown, the distal end of the extending arm 50 that is engaged with the pivot point 60 of flange portion 58 will have pivoted about that pivot point 60 when moved from the fully open position of the bottom glass member 16 to the partially open position.

The extending arm 50 of the illustrated embodiment provides apertures 68 and 74 for one fully open position and one partially open position, respectively. However, it is contemplated that the extending arm can have additional apertures along its length to provide for additional intermediate or partially open positions for the bottom glass member 16.

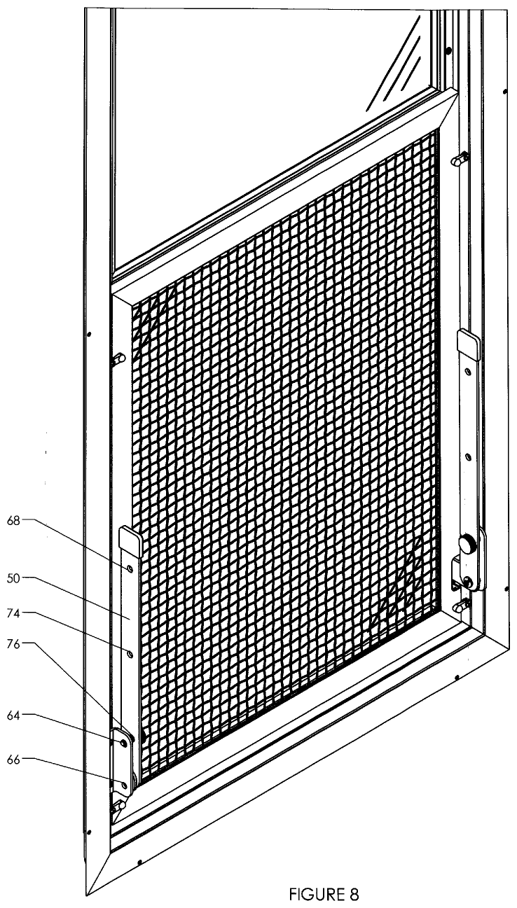

FIG. 8 illustrates the bottom glass member 16 in its closed position relative to the master frame 12. In this configuration, the bottom edge of the bottom frame 26 of bottom glass member 16 is adjacent to the master frame 12 and the screen frame 30. When in this closed position, a third aperture 76 of extending arm 50 (clearly visible in FIGS. 6 and 7) will be aligned with the upper aperture 64 of flange portion 62. In order to lock the extending arm 50 in this position, a post of locking member 56 is engaged with both the upper aperture 64 and the third aperture 76 until these components are secured. In cases where the bottom glass member 16 is being moved from either its fully open position or its partially open position to this closed position, the extending arms 50 are pulled toward the user through their associated openings 72 until the bottom glass member 16 is adjacent to the master frame 12 (i.e., until the glass member 16 is in its closed position). The extending arm 50 is pivoted about pivot point 60 until it is generally vertical and the third aperture 76 is aligned with the upper aperture 64. Locking member 56 is then inserted through both the upper aperture 64 and the third aperture 76. As shown, the distal end of the extending arm that is engaged with the pivot point 60 of flange portion 58 will have pivoted about that pivot point 60 when moved from the fully open position of the bottom glass member 16 to the closed position.

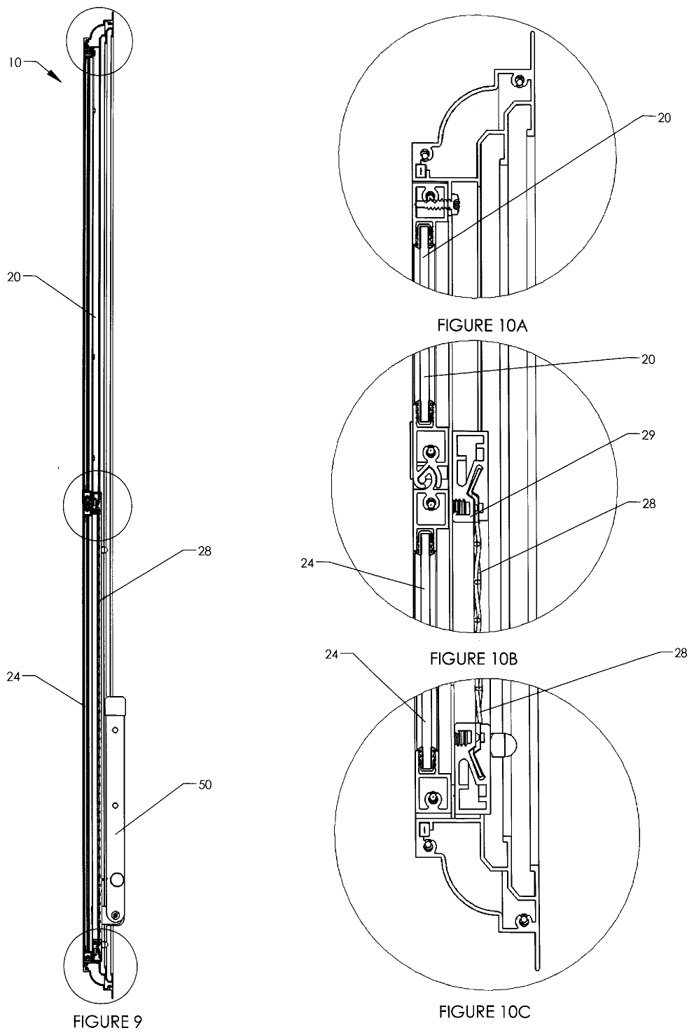

FIG. 9 is a cross-sectional side view of the window assembly 10 with the bottom glass member 16 in a closed position, and FIGS. 10A-10C provide enlarged views of portions of the window assembly 10 that illustrate exemplary relationships of the various panels relative to each other. As shown, the glass panels 20, 24 of the top glass member 14 and the bottom glass member 16, respectively, are generally aligned with each other along the height of the opening within the master frame 12. The mesh or screen panel 28 is offset relative to the glass panels 20, 24 of the top glass member 14 and the bottom glass member 16.

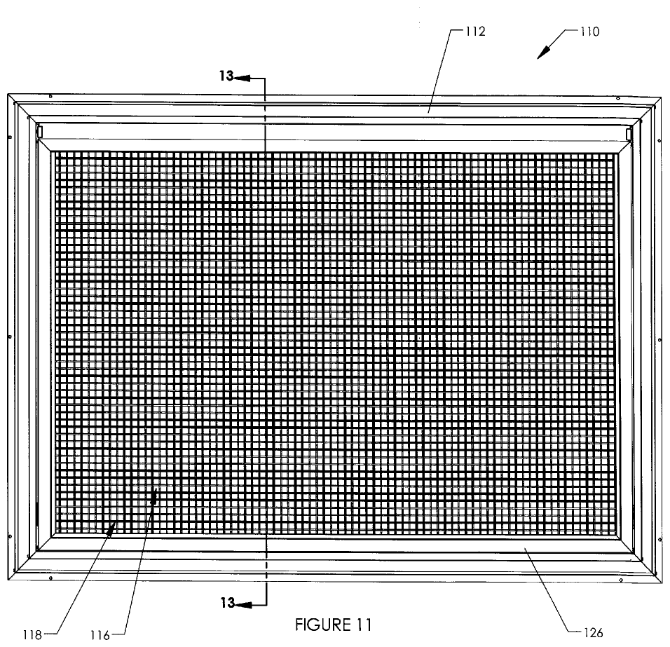

FIGS. 11 through 14B illustrate another embodiment of a of a window assembly 110, which includes a master frame 112 and a glass member 116 through which a bottom screen or mesh member 118 is visible. In this configuration, no additional top glass panel is included, but the assembly is otherwise similar to that of FIGS. 1-10C. As such, glass member 116 includes a glass panel 124 mounted within a frame 126. Glass member 116 is positioned within the master frame 112 at a hinged connection so that the glass member 116 can be swung outwardly to allow for ventilation, as will be discussed in further detail below.

The screen or mesh member 118 includes a screen or mesh panel 128 optionally mounted within a screen frame 130. Screen or mesh member 118 or screen frame 130 can be attached within the master frame 112 in a number of ways, such as by sliding the screen frame 130 into inner rails of the master frame 112 or by positioning it adjacent to the inner opening of the master frame 112 and locking it into place using one or more clips (not visible). Alternatively, the screen or mesh member 118 can be secured directly to the master frame 112. Multiple clips (e.g., four clips) can be generally positioned on the side of the window assembly facing toward the inside of the building to provide access to remove and replace the screen or mesh member 118, for example, although it is possible that the screen member is held in place in another manner.

As with the embodiment of window assembly 10, the master frame 112 and the screen frame 130 may be constructed in any of a number of ways, such as may include a sill, a header, and left and right jambs. Each of these four structural members includes mitered ends and is connected to an adjacent frame member with one or more fasteners (e.g., screws), adhesive, or other means when the frame is assembled. The frames 112 and 130 can be made of extruded aluminum, molded or extruded plastic, or another relatively rigid material that is resistant to damage by impact and/or environmental factors.

Briefly referring to the enlarged cross-sectional views of FIGS. 14A and 14B, at least one of the structural members of the optional screen frame 130 may include a base 129 having an opening in which an edge of the screen panel 128 can be inserted, and a moveable portion that is pivoted or moved toward the base 129 until it deforms or crimps the screen panel 128 within a predefined channel between the moveable portion and base. The channel can be configured with a different number and shape of contours and/or bends than illustrated. The process of crimping an edge of the screen panel 128 within each structural member is repeated for all four members of the screen frame 130.

The screen material used as the screen panel 128 can be stainless steel or another material that provides a desired amount of strength and rigidity, while also being relatively resistant to environmental factors, such as corrosion. The material from which the screen is made can include wires arranged in a grid pattern that is at least somewhat more open than that of a traditional insect screen in order to accommodate the thicker wires while still providing enough open space for viewing and/or air movement through the screen. In certain embodiments, the grid pattern can be less open than that of a traditional insect screen. In other embodiments, the material used as the screen panel can be perforated sheet metal, expanded sheet metal, or other material known to one skilled the art that provides both air circulation and resistance to entry by birds or other animals. In still other embodiments, the window assemblies can include a secondary insect screen that can be positioned across at least a portion of the screen panel 28. This optional secondary screen can have a grid or opening pattern that is the same as or different than that of the screen panel 28.

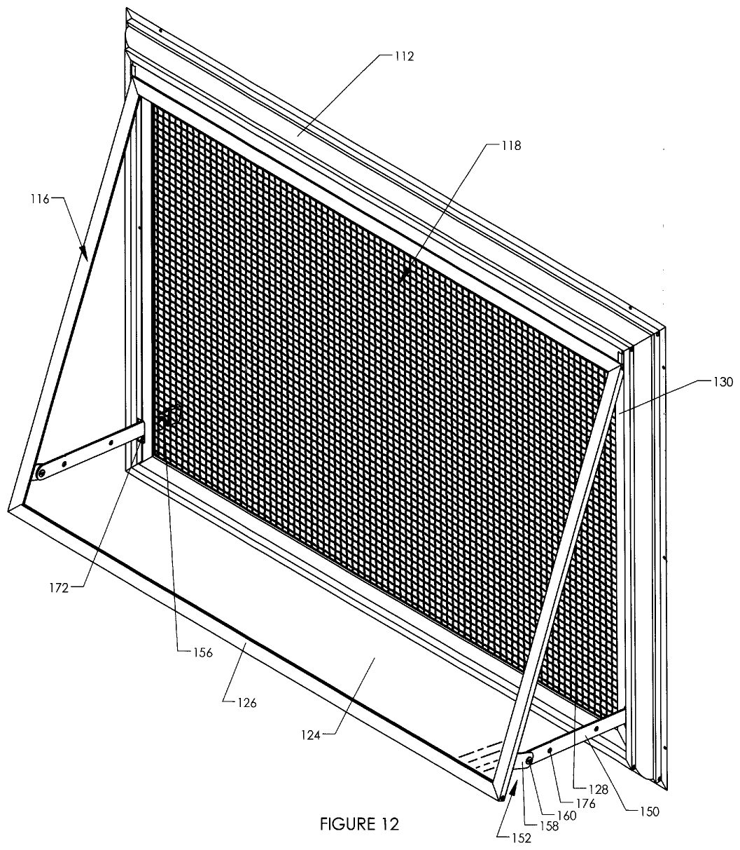

Referring particularly to FIG. 12, the glass member 116 is illustrated in one of its open positions, which in this embodiment is considered to be the fully open position of the bottom glass member 116. As shown, the top corners of the frame 126 are hinged so that the bottom edge of the frame 126 is spaced furthest from the master frame 112. In order to move the frame 126 away from the master frame 112, a window opening system is provided along one or both sides of the bottom frame 126 which generally includes an extending arm 150, a first bracket 152 secured to an inner side of the frame 126, a second bracket (not visible) secured to an inner side of the master frame 112, and a locking member 156. First bracket 152 is a generally L-shaped member having a flange portion 158 that extends outwardly in a generally perpendicular direction from the inner surface of the bottom frame 126 to which it is attached. Flange portion 158 includes a pivot point 160 at which a distal end of the extending arm 150 is pivotally attached.

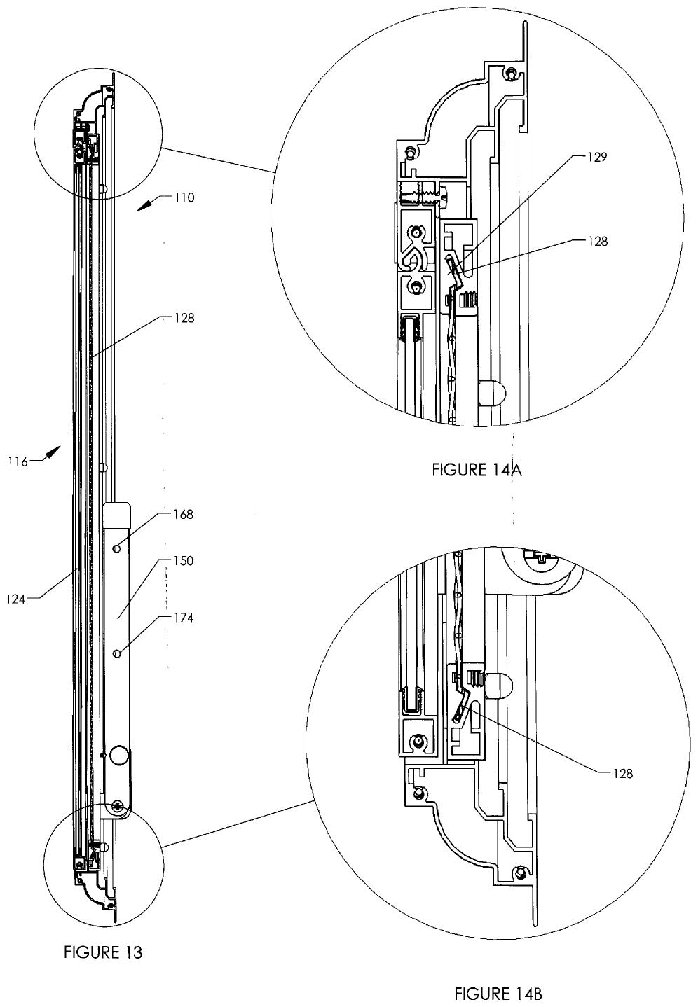

The second bracket, which is located on the opposite side of the master frame 112 than is visible in the drawings, is also a generally L-shaped member having a flange portion that extends outwardly in a generally perpendicular direction from an inner surface of the master frame 112 to which it is attached. This flange portion includes at least an upper aperture and a lower aperture for engagement with a corresponding aperture of the extending arm 150. In particular, when in this fully open position, a distal most aperture 168 (visible in FIG. 13) of extending arm 150 will be aligned with the lower aperture of the flange portion of the second bracket. In order to lock the extending arm 150 in this position, a post (which may be threaded) of locking member 156 is inserted through the lower aperture of the second bracket and the first aperture of the extending arm 150 until these components are secured. In one embodiment, the locking member 156 includes a knob from which a threaded post extends for engagement with corresponding threads of one or both of the apertures in which it is inserted.

As is illustrated in the Figures, the optional screen frame 130 includes a gap or opening 172 for each corresponding extending arm 150. These openings 172 can be located near the bottom left corner and bottom right corner of the screen frame 130, as shown, or it is also possible that the openings 172 and corresponding extending arms 150 are differently spaced relative to the corners of the screen frame 130. As with the embodiment of window assembly 10, when a screen frame is not utilized and the screen or mesh member 118 is secured directly to the master frame 112, a gap or opening 172 for each corresponding extending arm 150 may extend directly through the screen or mesh member 118.

As shown, the extending arm 150 includes additional apertures 174 and 176 for engagement with the upper and lower apertures of the flange portion extending from the inner side of the master frame 112. In particular, aperture 174 will be aligned with the lower aperture of the flange portion when the glass member 116 is in a partially open position and aperture 176 will be aligned with the upper aperture of the flange portion when the glass member 116 is in a closed position. The extending arm 150 of the illustrated embodiment provides apertures 168 and 174 for one fully open position and one partially open position, respectively. However, it is contemplated that the extending arm can have additional apertures along its length to provide for additional intermediate or partially open positions for the glass member 116.

FIG. 13 is a cross-sectional side view of the window assembly 110 with the glass member 116 in a closed position, and FIGS. 14A and 14B provide enlarged views of portions of the window assembly 110 that illustrate exemplary relationships of the various panels relative to each other.

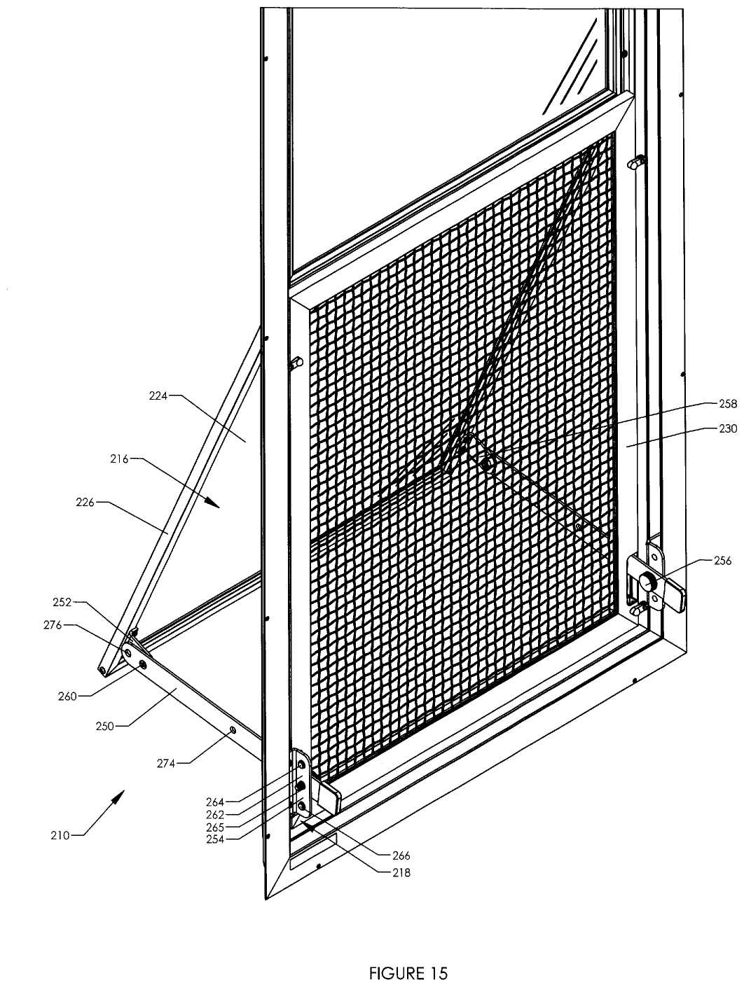

FIGS. 15-17 illustrate another embodiment of a lower portion of a window assembly 210 that includes a number of the same components as those discussed above relative to other embodiments of the invention, such as a master frame, a top glass member (not shown), a bottom glass member 216, and a bottom fixed member 218. Note that while member 218 is referred to as “fixed”, it is understood that this is a relative term that refers to a member that is generally not pivotable relative to the master frame. However, member 218 can be removable and/or replaceable, as desired. The bottom glass member 216 includes a glass panel 224 mounted within a bottom frame 226. Bottom glass member 216 is positioned adjacent to the top glass member at a hinged connection so that the bottom glass member 216 can be swung outwardly to allow for ventilation. The bottom fixed member 218 generally includes a screen or mesh panel optionally mounted within a screen frame 230.

Referring particularly to FIG. 15, the bottom glass member 216 is illustrated in one of its open positions, which in this embodiment is considered to be the fully open position of the bottom glass member 216. The top corners of the bottom frame are hinged so that the bottom edge of the bottom frame 226 is spaced furthest from the master frame. In order to move the bottom frame away from the master frame, a window opening system is provided along one or both sides of the bottom frame 226, which generally includes an extending arm 250, a first bracket 252 secured to an inner side of the bottom frame 226, a second bracket 254 secured to an inner side of the master frame, and a locking member 256. Details of this system are described in further detail below.

First bracket 252 is a generally L-shaped member having a flange portion 258 that extends outwardly in a generally perpendicular direction from the inner surface of the bottom frame 226 to which it is attached. Flange portion 258 includes a pivot point 260 to which extending arm 250 is pivotally attached, wherein the pivotal attachment point of the extending arm 250 is spaced proximally from its distal end. The first bracket 252 can be a separate piece that is attached to the frame 226 or can be integral with the frame 226.

Second bracket 254 is also a generally L-shaped member having a flange portion 262 that extends outwardly in a generally perpendicular direction from an inner surface of the master frame to which it is attached. The second bracket 254 can be a separate piece that is attached to the master frame or can be integral with the master frame. Flange portion 262 includes at least two apertures, and in this embodiment includes three apertures: an upper aperture 264, a middle aperture 265, and a lower aperture 266 for engagement with a corresponding aperture of the extending arm 250.

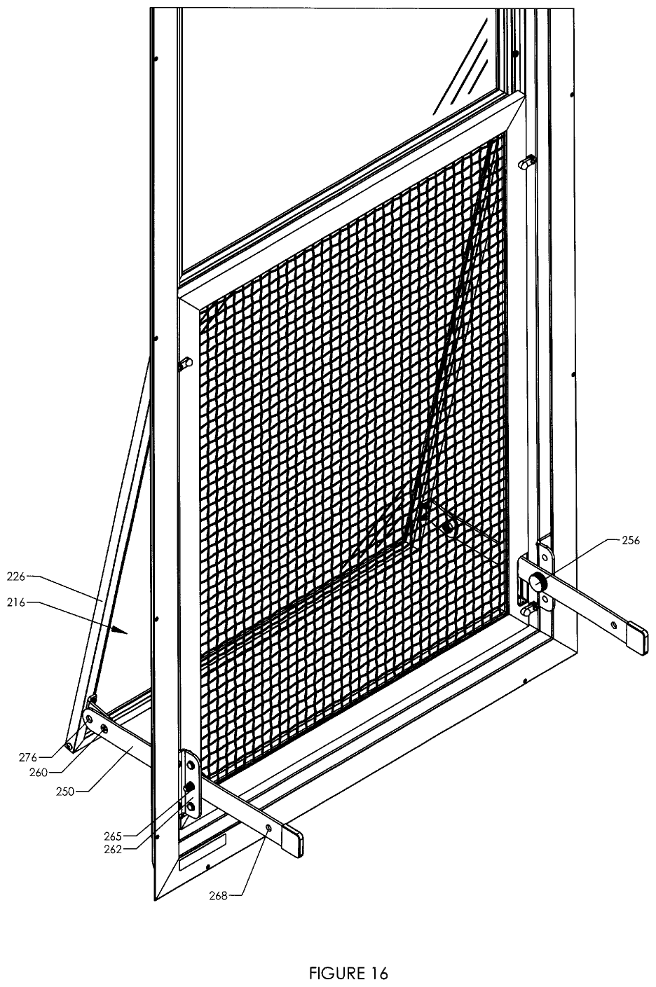

When the bottom glass member 216 is in this fully open position, a first aperture 268 of extending arm 250 (clearly visible in FIG. 16) will be aligned with the middle aperture 265 of flange portion 262. In order to lock the extending arm 250 in this position, a post (which may be threaded) of locking member 256 is inserted through both the middle aperture 265 of flange portion 262 and the first aperture 268 of extending arm 250 until these components are secured. In one embodiment, the locking member 256 includes a knob from which a threaded post extends, while the inner portion of one or both of the apertures 265, 268 includes corresponding threads such that the knob can be turned and tightened until the threads of the post are adequately secured within the apertures 265, 268.

Referring now to FIG. 16, the bottom glass member 216 is illustrated in another of its open positions, which in this embodiment is considered to be a partially open position of the bottom glass member 216. In this configuration, the bottom edge of the bottom frame 226 of bottom glass member 216 is closer to the master frame than when in its fully open position. When in this partially open position, a second aperture 274 of extending arm 250 (clearly visible in FIG. 15) will be aligned with the middle aperture 265 of flange portion 262. In order to lock the extending arm 250 in this position, a post of locking member 256 is inserted into both the middle aperture 265 and the second aperture 274 until these components are secured. In cases where the bottom glass member 216 is being moved from its fully open position to the partially open position, the locking member 256 is disengaged from the middle aperture 265 and first aperture 268, the extending arms 250 are pulled toward the user through associated openings in the frame until the second aperture 274 is aligned with the middle aperture 265, and then the locking member 256 is inserted through both the middle aperture 265 and the second aperture 274. As shown, the extending arm 250 may have pivoted at least slightly about the pivot point 260 when moved from the fully open position of the bottom glass member 216 to the partially open position.

The extending arm 250 of the illustrated embodiment provides at least the apertures 268 and 274 for one fully open position and one partially open position, respectively. However, it is contemplated that the extending arm can have one or more additional apertures along its length to provide for additional intermediate or partially open positions for the bottom glass member 216.

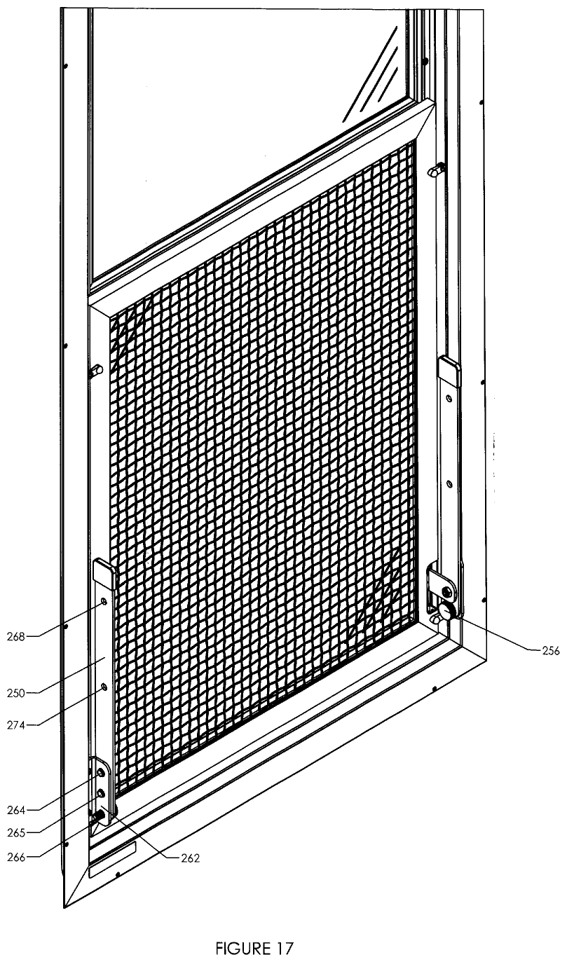

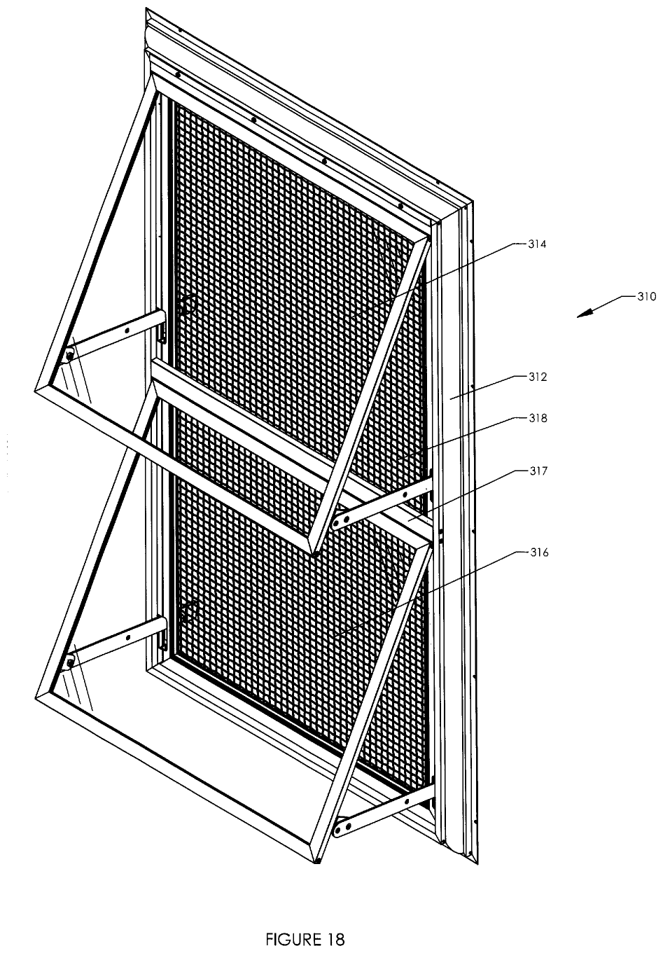

FIG. 17 illustrates the bottom glass member 216 in its closed position relative to the master frame. In this configuration, the bottom edge of the bottom frame 226 of bottom glass member 216 is adjacent to the master frame and the screen frame 230. When in this closed position, a third aperture 276 that is adjacent to a distal end of extending arm 250 (clearly visible in FIGS. 15 and 16) will be aligned with the lower aperture 266 of flange portion 262. In order to lock the extending arm 250 in this position, a post of locking member 256 is engaged with both the lower aperture 266 and the third aperture 276 of extending arm 250 until these components are secured. In cases where the bottom glass member 216 is being moved from either its fully open position or its partially open position to this closed position, the extending arms 250 are pulled toward the user through their associated openings in the frame until the bottom glass member 216 is adjacent to the master frame (i.e., until the glass member 216 is in its closed position). The extending arm 250 is pivoted about pivot point 260 until it is generally vertical and the third aperture 276 is aligned with the lower aperture 266. Locking member 256 is then inserted through both the lower aperture 266 and the third aperture 276.

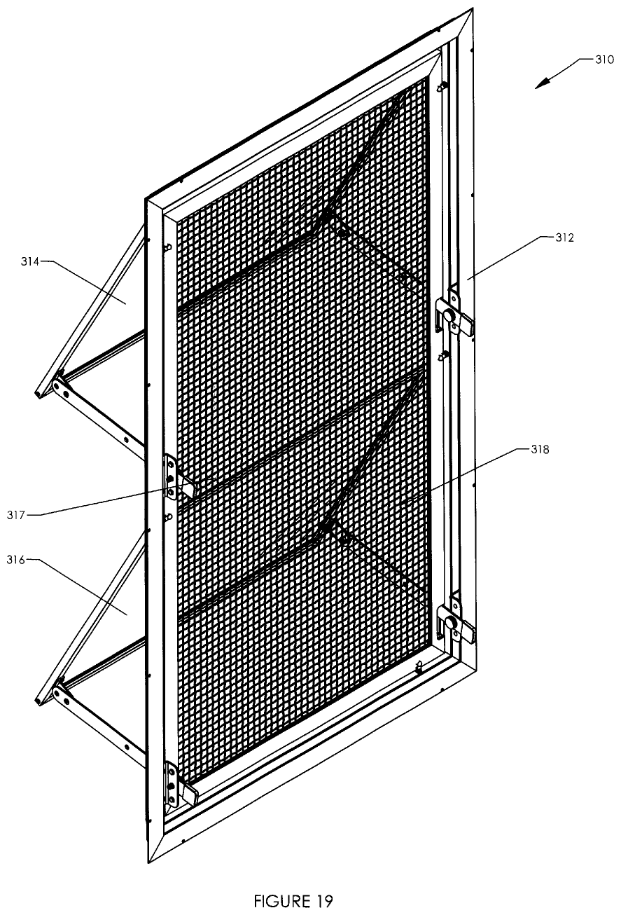

FIGS. 18 and 19 illustrate an embodiment of a of a window assembly 310, which includes a master frame 312, a top window member 314, and a bottom window member 316. A screen or mesh member 318 is positioned in the master frame 310, and can either be a single screen panel or can include more than one screen panel (e.g., separate screen panels that coincide with each of the window members). Both of the window members 314, 316 are connected within the master frame at a hinged connection so they can independently be swung outwardly to allow for ventilation. In an embodiment, window member 314 can be hinged generally along its top edge relative to a top member of the master frame, while the window member 316 can be hinged along an additional optional cross member 317 that extends generally across the width of the master frame 312.

In order to move the window members 314, 316 to their respective open positions, each of the window members 314, 316 is provided with a window opening system which generally includes one or more extending arms that are configured in any of the manners discussed herein relative to window opening systems. For example, the window opening systems may include one or more brackets and/or one or more locking members, as are described herein. The window opening systems can further be configured with their one or more extending arms being pivotably attached at a distal end of these arm(s) or can be pivotably attached at a pivot point that is spaced from a distal end of these arm(s).

Although FIGS. 18 and 19 illustrate two like-sized window members positioned vertically adjacent to each other, it is understood that a wide variety of configurations are contemplated and considered to be within the scope of the invention. For one example, the window assembly may include more than two moveable window members, wherein the glass members may be positioned horizontally and/or vertically adjacent to each other. In such configurations, additional cross members similar to cross member 317 may optionally be provided for connection or seating of the various window members within a single master frame. For another example, one or more fixed window members can be adjacent to one or more moveable window members, in any sequence of fixed and moveable members. For another example, the various window members can include at least one differently-sized window in a window assembly that includes multiple window members. Any or all of the various moveable window members can be provided with one or more screens positioned across their respective openings.

With regard to embodiments discussed herein, one or more extending arms of a window assembly may additionally or alternatively be frictionally engageable with a hole in a screen member and/or a screen frame to position the corresponding window assembly in one or more open, partially open, or closed positions. Such a frictional engagement may be facilitated by the materials from which the periphery of the hole and the outside surfaces of the extending arm are made that allow for sufficient friction between the surfaces that contact each other. In these embodiments, the extending arm may either include one or more apertures that additionally allow for engagement with a locking member, or may not be provided with such apertures. When the extending arm(s) are frictionally engageable with opening(s), the master frame may or may not include an extending flange.

While the embodiments discussed above have primarily been described in the context of enhancing a window opening in a building, the invention may also be used to enhance other building openings such as windows in doors. In addition, it is contemplated that screen panels and glass panels may be interchanged with each other relative to the described embodiments to provide for window assemblies that are arranged in different configurations than those described above. Further, although the described embodiments refer to the screen member and glass members as being “top” and “bottom” assemblies, it is contemplated that the various components can be arranged differently relative to each other.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

What is claimed is:

1. A window assembly comprising:
a master frame comprising an inner peripheral edge defining a master frame opening;
a first window assembly secured within a first portion of the master frame opening;
a screen member secured within a second portion of the master frame opening adjacent to the first window assembly;
a second window assembly pivotably attached relative to the second portion of the master frame opening; and
a window opening system comprising:
at least one extending arm pivotably attached to the second window assembly and extending through an opening in at least one of the master frame, the screen member, and a screen frame in which the screen member is secured, the at least one extending arm comprising at least one arm aperture;
at least one flange extending from the master frame and comprising at least one flange aperture; and
at least one locking member engageable with one of the at least one arm aperture and one of the at least one flange aperture.

2. The window assembly of claim 1, wherein the at least one extending arm is pivotably attached at a distal end to the second window assembly.

3. The window assembly of claim 1, wherein the at least one extending arm is pivotably attached to the second window assembly at a pivot point spaced from a distal end of the at least one extending arm.

4. The window assembly of claim 1, wherein the at least one arm aperture comprises a plurality of arm apertures.

5. The window assembly of claim 1, wherein the at least one flange aperture comprises a plurality of flange apertures.

6. The window assembly of claim 1, wherein the at least one arm aperture comprises a plurality of arm apertures and wherein the at least one flange aperture comprises a plurality of flange apertures.

7. The window assembly of claim 1, wherein the at least one arm aperture comprises a first arm aperture and a second arm aperture, and wherein the at least one flange aperture comprises a first flange aperture and a second flange aperture such that the first arm aperture is alignable with the first flange aperture when the second window assembly is in a first window position and such that the second arm aperture is alignable with the second flange aperture when the second window assembly is in a second window position.

8. The window assembly of claim 7, wherein the at least one locking member is engaged with the first arm aperture and the first flange aperture when the second window assembly is in the first window position, and wherein the at least one locking member is engaged with the second arm aperture and the second flange aperture when the second window assembly is in the second window position.

9. The window assembly of claim 1, wherein the screen member comprises a grid of wires.

10. The window assembly of claim 1, further comprising a secondary screen covering at least a portion of the screen member.

11. The window assembly of claim 1, wherein the distal end of the extending arm is positioned on a first side of the master frame and a proximal end of the extending arm is positioned on a second side of the master frame that is opposite the first side.

12. A window assembly comprising:
a master frame comprising an inner peripheral edge defining a master frame opening;
a screen member secured within the master frame opening;
a first window assembly pivotably attached relative to the master frame opening; and
a window opening system comprising:
at least one extending arm pivotably attached to the first window assembly and extending through an opening in at least one of the master frame, the screen member, and a screen frame in which the screen member is secured, the at least one extending arm comprising at least one arm aperture;
at least one flange extending from the master frame and comprising at least one flange aperture; and
at least one locking member engageable with one of the at least one arm aperture and one of the at least one flange aperture.

13. The window assembly of claim 12, wherein the at least one extending arm is pivotably attached at a distal end to the first window assembly.

14. The window assembly of claim 12, wherein the at least one extending arm is pivotably attached to the first window assembly at a pivot point spaced from a distal end of the at least one extending arm.

15. The window assembly of claim 12, wherein the at least one arm aperture comprises a plurality of arm apertures.

16. The window assembly of claim 12, wherein the at least one flange aperture comprises a plurality of flange apertures.

17. The window assembly of claim 12, wherein the at least one arm aperture comprises a plurality of arm apertures and wherein the at least one flange aperture comprises a plurality of flange apertures.

18. The window assembly of claim 12, wherein the at least one arm aperture comprises a first arm aperture and a second arm aperture, and wherein the at least one flange aperture comprises a first flange aperture and a second flange aperture such that the first arm aperture is alignable with the first flange aperture when the first window assembly is in a first window position and such that the second arm aperture is alignable with the second flange aperture when the first window assembly is in a second window position.

19. The window assembly of claim 18, wherein the at least one locking member is engaged with the first arm aperture and the first flange aperture when the first window assembly is in the first window position, and wherein the at least one locking member is engaged with the second arm aperture and the second flange aperture when the first window assembly is in the second window position.

20. The window assembly of claim 12, wherein the screen member comprises a grid of wires.

21. The window assembly of claim 12, further comprising a secondary screen covering at least a portion of the screen member.

22. The window assembly of claim 12, wherein the distal end of the at least one extending arm is positioned on a first side of the master frame and a proximal end of the at least one extending arm is positioned on a second side of the master frame that is opposite the first side.

23. The window assembly of claim 12, further comprising at least a second window assembly that is one of pivotably attached and fixedly attached relative to the master frame opening.

24. A window assembly comprising:
a master frame comprising an inner peripheral edge defining a master frame opening;
a screen member secured within the master frame opening;
a first window assembly pivotably attached relative to the master frame opening; and
a window opening system comprising:
at least one extending arm pivotably attached to the first window assembly and extending through an opening in at least one of the master frame, the screen member, and a screen frame in which the screen member is secured, the at least one extending arm being frictionally engageable with the opening to position the first window assembly in at least one open position.

25. The window assembly of claim 24, further comprising at least a second window assembly that is one of pivotably attached and fixedly attached relative to the master frame opening.
